(19) United States
(12) Patent Application Publication
(10) Pub. No.: US 2024/0015618 A1
(43) Pub. Date: Jan. 11, 2024

(54) METHODS, DEVICES AND COMPUTER READABLE MEDIA FOR COMMUNICATIONS

(71) Applicant: NEC CORPORATION, Tokyo (JP)

(72) Inventors: Zhe CHEN, Beijing (CN); Gang WANG, Beijing (CN)

(73) Assignee: NEC Corporation, Tokyo (JP)

(21) Appl. No.: 18/026,883

(22) PCT Filed: Sep. 18, 2020
(86) PCT No.: PCT/CN2020/116270

§ 371 Date: Mar. 17, 2023

(51) Int. Cl. H04W 36/02; H04W 36/00

(52) U.S. Cl. CPC H04W 36/026; H04W 36/00837; H04W 36/0061; H04W 36/0058; H04W 36/0235; H04W 88/06

(57) ABSTRACT

Embodiments of the present disclosure relate to methods, devices and computer readable media for communications. A method comprises receiving, at a terminal device and from a network device, a first message indicative of a switching condition for the terminal device to switch to a second service providing mode, the terminal device being served by the network device in a first service providing mode. The method further comprises: in accordance with a determination that the switching condition is satisfied, establishing a connection with the network device to be served by the network device in the second service providing mode. In this manner, a dynamic and efficient switching process between multicast mode and unicast mode can be autonomously triggered at the terminal device.

### TECHNICAL FIELD

Embodiments of the present disclosure generally relate to the field of telecommunication, and in particular, to methods, devices and computer readable media for communications.

### BACKGROUND

Wireless communication networks give users of terminal devices access to various multimedia contents and services, such as voice, video, packet data, and the like. To deliver content to a recipient, the content provider, such as a base station, may transmit packets of the content in unicast manner. Specifically, the unicast technology refers to a point-to-point transmission (PTP) mechanism in which packets are simply transmitted from the source entity to the destination, for example, a particular terminal device, a User Equipment (UE), etc.

The content provider may also deliver multimedia content in multicast manner. The multicast technology refers to a point-to-multipoint (PTM) transmission mechanism in which packets are transmitted from a single source entity to multiple recipients for allowing network resources to be shared. As one of multicast technologies, Multimedia Broadcast Multicast Service (MBMS) has been proposed to facilitate high bandwidth communication for multimedia. In MBMS, groups of source entities can transmit signal carrying the content in a synchronized manner, so that signals reinforce one another rather than interfere with each other at the recipient. In the context of MBMS, the shared content is transmitted from multiple network devices of a communication network to multiple terminal devices. Therefore, within a given MBMS area, a terminal device may receive MBMS signals from any network device(s) within the radio range. The terminal device may then decode the MBMS signal with configuration information received on Multicast Control Channel (MCCH).

### SUMMARY

In general, example embodiments of the present disclosure provide methods, devices and computer readable media for communications.

In a first aspect, there is provided a method for communications. The method comprises receiving, at a terminal device and from a network device, a first message indicative of a switching condition for the terminal device to switch to a second service providing mode, the terminal device being served by the network device in a first service providing mode. The method further comprises in accordance with a determination that the switching condition is satisfied, establishing a connection with the network device to be served by the network device in the second service providing mode.

In a second aspect, there is provided a method for communications. The method comprises: transmitting, to a terminal device, a first message indicative of a switching condition for serving the terminal device in a second service providing mode, the terminal device being served by the network device in a first service providing mode; and performing an establishment of a connection with the terminal device for serving the terminal device in the second service providing mode.

In a third aspect, there is provided a method for communications. The method comprises: transmitting, at a first network device and to a first terminal device, a second message indicating switching information for the first terminal device to switch to a second service providing mode, the first terminal device being served by the first network device in a first service providing mode; and serving the first terminal device in the second service providing mode.

In a fourth aspect, there is provided a method for communications. The method comprises: receiving, at a first terminal device and from a first network device, a second message indicating switching information for the first terminal device to switch to a second service providing mode, the first terminal device being served by the first network device in a first service providing mode; and establishing, based on the switching information, a connection with the first network device to be served by the first network device in the second service providing mode.

In a fifth aspect, there is provided a terminal device. The first terminal device comprises a processor and a memory storing instructions. The memory and the instructions are configured, with the processor, to cause the terminal device to perform the method according to the first aspect.

In a sixth aspect, there is provided a terminal device. The terminal device comprises a processor and a memory storing instructions. The memory and the instructions are configured, with the processor, to cause the terminal device to perform the method according to the third aspect.

In a seventh aspect, there is provided a network device. The network device comprises a processor and a memory storing instructions. The memory and the instructions are configured, with the processor, to cause the network device to perform the method according to the second aspect.

In an eighth aspect, there is provided a network device. The network device comprises a processor and a memory storing instructions. The memory and the instructions are configured, with the processor, to cause the network device to perform the method according to the fourth aspect.

In a ninth aspect, there is provided a computer readable medium having instructions stored thereon. The instructions, when executed on at least one processor of a device, cause the device to perform the method according to the first aspect or the third aspect.

In a tenth aspect, there is provided a computer readable medium having instructions stored thereon. The instructions, when executed on at least one processor of a device, cause the device to perform the method according to the second aspect or the fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates a diagram of an example communication network in which implementations of the present disclosure can be implemented;

FIG. 2 illustrates an example signaling chart showing an example process for a terminal device-based switching from multicast to unicast in accordance with some embodiments of the present disclosure;

FIG. 3 illustrates a flowchart of an example method in accordance with some embodiments of the present disclosure;

FIG. 4 illustrates a flowchart of an example method in accordance with some embodiments of the present disclosure;

FIG. 5 illustrates an example signaling chart showing an example process for a network device-based switching between multicast and unicast in accordance with some embodiments of the present disclosure;

FIG. 6 illustrates a flowchart of an example method in accordance with some embodiments of the present disclosure;

FIG. 7 illustrates a flowchart of an example method in accordance with some embodiments of the present disclosure; and

FIG. 8 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like.

As used herein, the term ‘network device’ or ‘base station’ (BS) refers to a device which is capable of providing or managing a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

The MBMS service area may include one or more cells managing by one or more terminal devices, where a certain service is supported to be provided in multicast mode. As described above, in the MBMS service area, both unicast and multicast services are provided to the terminal device. In some situations, the network device may expect to provide a service from one service providing mode to another service providing mode. By way of example, in a case where less and less terminal devices are interested in MBMS services, the network device may expect to switch the multicast mode to the unicast mode. In some other situations, when more and more terminal devices are interested in MBMS services, the network device may expect to switch the unicast mode to the multicast mode. From the perspective of terminal device, there is also a demand of autonomously switching from multicast to unicast.

In conventional communication systems, for example, in a LTE communication network, the unicast sessions and multicast sessions are built on independent channels with no association with each other. The switching between the multicast mode and the unicast mode is initiated and controlled by the network device. There is no efficient mechanism for enabling the terminal device to autonomously switch between the unicast mode and the multicast mode. Furthermore, there is a demand for the communication network to support both intra-cell and inter-cell switches from broadcast/multicast service delivery to unicast service delivery and vice versa. There is no mechanism for enabling a dynamic switch between unicast and multicast.

In order to solve the above and other potential problems, embodiments of the present disclosure provide a dynamic and smooth procedure for switching between PTP and PTM modes and an efficient signaling mechanism for implementing such a switching procedure, either at the terminal device side or at the network device side.

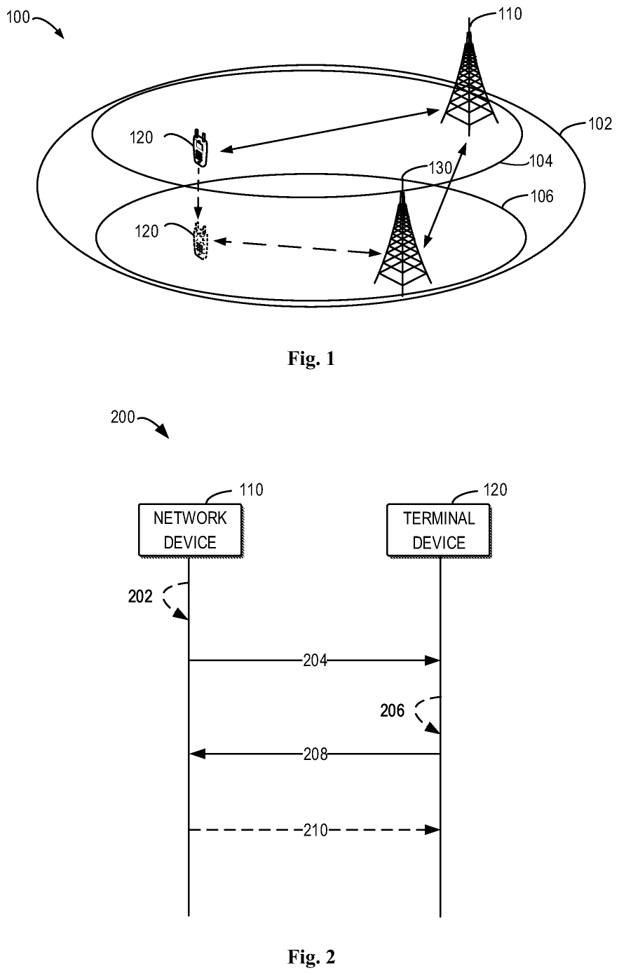

FIG. 1 illustrates a schematic diagram of an example communication environment 100 in which embodiments of the present disclosure can be implemented. As shown in FIG. 1, the communication environment 100, which is a part of a communication network, includes network devices 110 and 130, and a terminal device 120. The network devices 110 and 130 may communicate with the terminal device 120 via respective wireless communication channels. In addition, the network devices 110 and 130 may communicate with each other, which will be discussed below in details.

In FIG. 1, the network devices 110 and 130 and the terminal device 120 are shown as base stations and a UE, respectively. It is to be understood that embodiments of the present disclosure are also applicable to any other suitable implementations. It is to be understood that the number of devices in FIG. 1 is given for the purpose of illustration without suggesting any limitations to the present disclosure. The communication environment 100 may include any suitable number of network devices and/or terminal devices as well as additional elements not shown adapted for implementing implementations of the present disclosure, without suggesting any limitation as to the scope of the present disclosure.

The network device 110 manages a cell 104, while the network device 130 manages a cell 106. Both the network devices 110 and 130 can support MBMS services, and the coverage area 102 of the network devices 110 and 130 may form a MBMS area 102. As discussed above, within the MBMS area 102, the network devices 110 and 130 may deliver services to terminal device 120 in both unicast manner and multicast manner. The terminal device 120 may move within the coverage area 102. As shown in FIG. 1, the terminal device 120 is initially located within the cell 104, which may also be referred to as a source cell 104, and the network device 110 serves as a source network device. As the terminal device 120 moves towards an edge of the cell 104 and then comes into the coverage of the cell 106, the handover from the source cell 104 to the cell 106 may be initiated. In this case, the cell 106 may also be referred to as the target cell 106 and the network device 130 serves as a target network device.

In order to access the coverage area 102 and built multicast sessions, the terminal device 120 needs to obtain system information block (SIB) associated with the network devices 110 and 130. The SIB may be broadcasted periodically by the network devices 110 and 130. SIBs can be classified in to groups named SIB1, SIB2 . . . , SIB13 and so on, and different SIBs may be defined based on the type of information included therein. For example, the SIB13 may be configured to include configurations regarding the MBMS area, such as, the MBSFNAreaConfiguration and MBMS control channel (MCCH) configurations. It is to be understood that any other suitable implementations of the SIB, whether currently known or to be developed in the future, are possible as well.

The communications in the communication network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

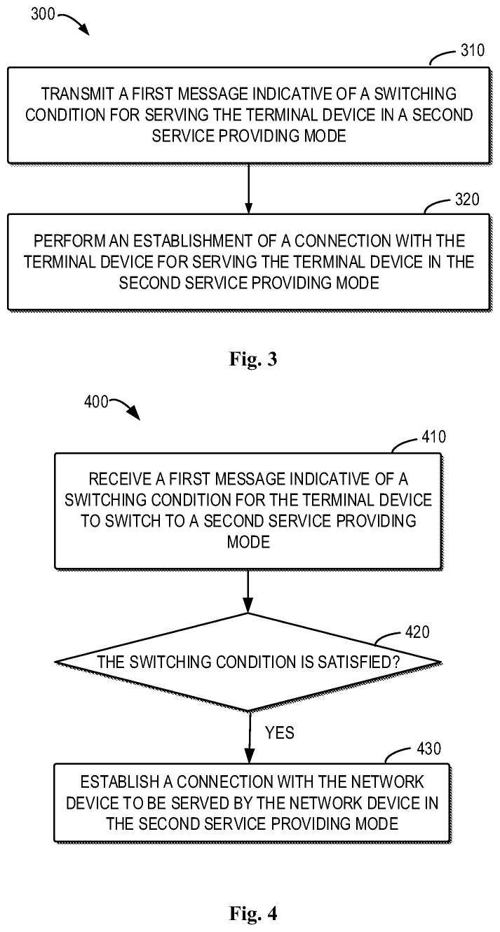

FIG. 2 illustrates an example signaling chart showing an example process 200 for a terminal device-based switching from multicast to unicast in accordance with some embodiments of the present disclosure. As shown in FIG. 2, the process 200 may involve the network device 110 and the terminal devices 120 as shown in FIG. 1. It is to be understood that the process 200 may include additional acts not shown and/or may omit some acts as shown, and the scope of the present disclosure is not limited in this regard. In addition, it will be appreciated that, although primarily presented herein as being performed serially, at least a portion of the acts of the process 200 may be performed contemporaneously or in a different order than as presented in FIG. 2.

The terminal device 120 may currently be served, by the network device 110, with a target service in a first service providing mode. As shown in FIG. 2, the network device 110 may determine 202 a switching condition for the terminal device 120 to switch to a second service providing mode. Each MBMS session or multicast service may be associated with a corresponding switching condition. In some example embodiments, the first service providing mode and the second service providing mode may be the multicast mode and the unicast mode, respectively.

The switching condition may be configured for the terminal device 120 to autonomously switch from the multicast mode to the unicast mode. For example, when the terminal device 120 is located at the edge of the cell 104 and served with the MBMS service, a first signal received from the network device 110 may be weak. The first signal may include a reference signal, a MBSFN signal and so on. In such a situation, a switching to the unicast mode may be required to ensure the service continuity. In this case, the switching condition may indicate that a signal strength value of the first signal received from the network device 110 does not exceed a predetermined signal strength threshold associated with the target service served in the first service providing mode. For each MBMS session or Multicast service, a corresponding signal strength threshold may be configured by the network device 110. For example, if the signal strength of the first signal received from the network device 110 is below the predetermined signal strength threshold, the terminal device 120 may initiate to setup a RRC connection for unicast, which will be discussed in details below.

In some other example embodiments, the switching condition may indicate that a first ratio of packets successfully received at the terminal device 120 in the first service providing mode to a total packets transmitted from the network device 110 in the first service providing mode in a certain period of time is below a predetermined ratio. In a case that the first ratio does not exceed the threshold ratio, a switching to the unicast mode may be desirable. In some example embodiments, the terminal device 120 may derive the first ratio based on Radio Link Control (RLC) packets or Media access control (MAC) protocol data units (PDUs).

The network device 110 transmits 204 a first message indicative of the switching condition for serving the terminal device 120 in the second service providing mode. In some example embodiments, the switching condition may be configured in the SIB received from the network device 110. By including the switching condition in the SIB, it may allow the terminal device 120 to monitor the SIB broadcasted in a particular cell, before a cell reselection of the cell is performed. As such, it is possible for the terminal device 120 to be handed over to a target cell with less delay caused by the established unicast connection.

The SIB may indicate a set of configurations to be transmitted on a control channel, for example, the MBSFNAreaConfiguration in the MCCH. In some other example embodiments, the switching condition may be configured in the set of configurations with less change on the structure of the configurations on the MCCH. In this case, the terminal device 120 may obtain the switching information from the set of configurations based on the SIB.

Upon receipt the first message, the terminal device 120 may determine 206 whether the switching condition is satisfied. For example, in a case where the switching condition is related to the signal strength threshold, the terminal device 120 may measure the signal strength value of the first signal, and determine whether the signal strength value exceeds the predetermined signal strength threshold. If the signal strength value does not exceed the predetermined signal strength threshold, the terminal device 120 may determine that the switching condition is satisfied, which indicates that the switching to the second service providing mode may be desirable.

In another case where the switching condition is related to the ratio of packets successfully received in the first service providing mode to the total packet transmitted in the first service providing mode, the terminal device 120 may receive the packets in the first service providing mode from the network device 110 and derive the first ratio. The terminal device 120 may then determine whether the first ratio exceeds the predetermined ratio. If the first ratio does not exceed the predetermined ratio, the terminal device 120 may determine that the switching condition is satisfied, which indicates that the switching to the second service providing mode may be desirable.

If the switching condition is satisfied, the terminal device 120 establishes 208 a connection with the network device 110 to be served by the network device 110 in the second service providing mode. In some embodiments, the network device 110 may serve 210 the terminal device 120 via the connection, for example, by transmitting packets of the service in the second service providing mode.

It is to be understood that the process 200 is also applicable for the switching from the unicast mode to the multicast mode implemented between the network device 110 and the terminal device 120.

FIG. 3 illustrates a flowchart of an example method 300 in accordance with some embodiments of the present disclosure. For example, the method 300 can be performed at the network device 110 as shown in FIGS. 1 and 2. It is to be understood that the method 300 may include additional blocks not shown and/or may omit some blocks as shown, and the scope of the present disclosure is not limited in this regard.

At 310, the network device 110 determines a switching condition for the terminal device 120 to switch to a second service providing mode. The terminal device 120 is served by the network device 110 in a first service providing mode. In some example embodiments, the first service providing mode may refer to a multicast mode, and the second service providing mode may refer to a unicast mode.

In some example embodiments, the network device 110 may determine the switching condition indicative of at least one of: a signal strength value of a first signal transmitted by the network device 110 being below a predetermined signal strength threshold, and a first ratio of packets successfully received at the terminal device 120 in the first service providing mode to a total packets transmitted from the network device 110 in the first service providing mode being below a predetermined ratio.

At 320, the network device 110 transmits, to the terminal device 120, a first message indicative of the switching condition for serving the terminal device 120 in the second service providing mode.

In some example embodiments, the network device 110 may determine the switching condition indicative of: a signal strength value of a first signal transmitted by the network device not exceeding a predetermined signal strength threshold. The network device 110 may transmit, to the terminal device 120, the switching condition in the SIB. An example of the SIB according to the example embodiments of the present disclosure is illustrated below. It is to be understood that the SIB type can be varied depending on the environments, communication standards, protocols, requirements, and/or other relevant factors. That is, the SIB type set forth herein is given as one example and should not be regarded as suggesting a limitation on the scope of the present disclosure. The SIB proposed in the embodiments of the present disclosure may be of any suitable SIB type, whether currently known or to be developed in the future.

```
SystemInformationBlockType13-r9 ::= SEQUENCE {
    mbsfn-AreaInfoList-r9 MBSFN-AreaInfoList-r9,
    notificationConfig-r9 MBMS-NotificationConfig-r9,
    Switchthreslist ::= SEQUENCE (SIZE (1..maxPLMN-r11)) OF Switchthreslist
  Switchthres ::= SEQUENCE {
MBMSSessioninfo ...,
Smbmsthres
}
```

In some other example embodiments, the network device 110 may transmit, to the terminal device 120, the SIB indicating a set of configurations to be transmitted on a control channel, and the set of configurations at least comprises the switching condition. In the embodiments, the network device 110 may then transmit, to the terminal device 120, the set of configurations including the switching condition on the control channel. For example, the SIB may be configured to indicate a set of configurations to be transmitted on the MCCH, such as, the MBSFNAreaConfiguration and MBMS control channel (MCCH) configurations. The switching condition may be included in the MBSFNAreaConfiguration to be transmitted in the MCCH with less change on the structure of legacy MBSFNAreaConfiguration, for example, the MBMS MBSFNAreaConfiguration used in LTE. An example of the MBSFNAreaConfiguration that includes the switching condition indicative of the signal strength threshold according to some embodiments of the present disclosure is illustrated below.

```
MBSFNAreaConfiguration-r9 ::= SEQUENCE{
pmch-InfoList-r9 PMCH-InfoList, }
PMCH-InfoList ::= SEQUENCE (SIZE (0..maxPMCH-PerMBSFN)) OF PMCH-Info
PMCH-Info ::= SEQUENCE {
  pmch-Config PMCH-Config-r9,
  mbms-SessionInfoList-r9 MBMS-SessionInfoList-r9,
  ...
}
MBMS-SessionInfo-r9 ::= SEQUENCE {
  tmgi-r9 TMGI-r9,
  sessionId-r9 OCTET STRING (SIZE (1))
  Smbmsthres
}
```

In some other example embodiments, the network device 110 may determine the switching condition indicative of a first ratio of packets successfully received at the terminal device in the first service providing mode to total packets transmitted from the network device in the first service providing mode not exceeding a predetermined ratio. The terminal device 120 may evaluate the first ratio based on the RLC packets, or MAC PDUs received in a certain period of time. In such embodiments, the switching condition may only be configured in MBSFNAreaConfiguration in MCCH, since before the terminal device 120 performs the cell reselection of a particular cell, it has not received any packet that could be used for evaluating the first ratio. An example of the MBSFNAreaConfiguration that includes the switching condition indicative of the predetermined ratio according to some embodiments of the present disclosure is illustrated below.

```
MBSFNAreaConfiguration-r9 ::= SEQUENCE {
pmch-InfoList-r9 PMCH-InfoList, }
PMCH-InfoList ::= SEQUENCE (SIZE (0..maxPMCH-PerMBSFN)) OF PMCH-Info
PMCH-Info ::= SEQUENCE {
  pmch-Config PMCH-Config-r9,
  mbms-SessionInfoList-r9 MBMS-SessionInfoList-r9,
  ...
}
MBMS-SessionInfo-r9 ::= SEQUENCE {
  tmgi-r9 TMGI-r9,
  sessionId-r9 OCTET STRING (SIZE (1))
  receiving ratio
}
```

FIG. 4 illustrates a flowchart of an example method 400 in accordance with some embodiments of the present disclosure. For example, the method 400 can be performed at the terminal device 120 as shown in FIGS. 1 and 2. It is to be understood that the method 400 may include additional blocks not shown and/or may omit some blocks as shown, and the scope of the present disclosure is not limited in this regard.

At 410, the terminal device 120 receives, from the network device 110, a first message indicative of a switching condition for the terminal device 120 to switch to a second service providing mode. The terminal device 120 is served by the network device 110 in a first service providing mode. In some example embodiments, the first service providing mode may refer to a multicast mode, and the second service providing mode may refer to a unicast mode.

The first message may be the SIB broadcasted by the network device 110. In some example embodiments, the terminal device 120 may receive the switching condition in the SIB from the network device 110. For example, the example of the SIB according to the embodiments of the present disclosure is shown above in connection with the description of the method 300.

Alternatively, in other example embodiments, the terminal device 120 may receive the SIB indicating a set of configurations to be transmitted on a control channel, such as, the MBSFNAreaConfiguration in MCCH, and the set of configurations at least includes the switching condition. The terminal device 120 may then obtain the switching condition from the set of configurations based on the SIB. For example, the examples of the MBSFNAreaConfiguration according to the embodiments of the present disclosure are shown above in connection with the description of the method 300.

At 420, the terminal device 120 determines whether the switching condition is satisfied. In some example embodiments, the switching condition may indicate that the signal strength value of the first signal received from the network device 110 does not exceed a predetermined signal strength threshold. In this case, the terminal device 120 may measure the signal strength value of the first signal, such as a reference signal, a MBMS signal received from the network device 110. If the signal strength value of the first signal does not exceed the signal strength threshold, the terminal device 120 may determin2 that the switching condition is satisfied.

In some other example embodiments, the switching condition may indicate that that the first ratio of packets successfully received at the terminal device 120 in the first service providing mode to total packets transmitted from the network device 110 in the first service providing mode does not exceed a predetermined ratio. In this case, the terminal device 120 may receive packets in the first service providing mode from the network device 110, such as, the RLD packets, MAC PDUs and the like. The terminal device 120 may then determine the first ratio based on the packets received from the network device 110. If the first ratio does not exceed the predetermined ratio, the terminal device 120 may determine that the switching condition is satisfied.

If the switching condition is determined to be satisfied, the terminal device 120, at 430, establishes a connection with the network device 110 to be served by the network device 110 in the second service providing mode. Upon the establishment of the unicast connection, the terminal device 120 switches to the unicast mode, and may be served with the service that is used to be served in the multicast mode in the unicast mode.

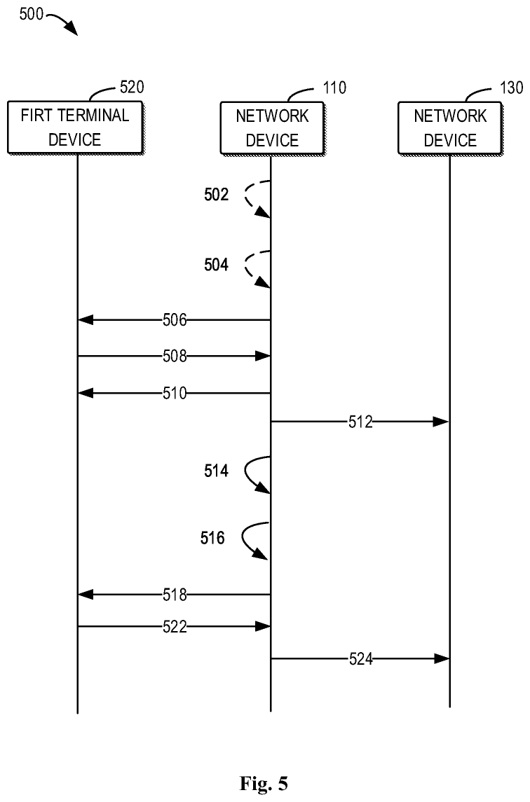

FIG. 5 illustrates an example signaling chart showing an example process 500 for a network device-based switching between multicast and unicast in accordance with some embodiments of the present disclosure. As shown in FIG. 5, the process 500 may involve the network device 110 and the terminal devices 120 as shown in FIG. 1. It is to be understood that the process 500 may include additional acts not shown and/or may omit some acts as shown, and the scope of the present disclosure is not limited in this regard. In addition, it will be appreciated that, although primarily presented herein as being performed serially, at least a portion of the acts of the process 500 may be performed contemporaneously or in a different order than as presented in FIG. 5.

In the coverage 102, each network devices may serve more than one terminal devices in both the multicast mode and the unicast mode. For example, the network device 110 may serve a group of terminal devices including the first terminal device 520 in a first service providing mode. When less and less terminal devices are interested in the service in the first service providing mode, the network device may expect to switch to the second service providing mode for saving system overhead and signaling. The network device 110 may determine that there is a demand to switch from the first service providing mode to the second service providing mode based on network statistics on at least one of the number of terminal devices interested in the service in the second service providing mode and the service type served to the terminal devices.

In a case where the terminal device 120 or 520 operates in RRC IDLE/INACTIVE mode, the terminal device 120 or 520 may not able to receive any RRC dedicated information to be guided to switch from multicast to unicast. Therefore, a network device-based switching mechanism between multicast and unicast may be desired to inform the terminal device to switch from one mode to another mode.

The network device 110 transmits 506 transmitting, to the first terminal device 520, a second message indicating switching information for the terminal device to switch to a second service providing mode. The first terminal device 520 is served by the network device 110 in the first service providing mode.

In some example embodiments, to determine when to trigger the transmission of the second message, the network device 110 may determine 502 a first service metric associated with a first terminal device 520. The first terminal device 520 is served by the network device 110 in the first service providing mode. The first service metric associated with the first terminal device 520 may include one of a number of terminal devices in a group where the first terminal device 520 is grouped in and a service type associated with the first terminal device 520.

In the above embodiments, the network device 110 may determine 504 whether a preconfigured switching condition is satisfied based on the first service metric. In some example embodiments, the network device 110 may determine the number of terminal devices in a group where the first terminal device 520 is grouped in. If the number of the terminal devices in the group is below a predetermined number threshold, the network device 110 may determine the preconfigured switching condition is satisfied. Alternatively, in other example embodiments, the network device 110 may determine a service type associated with the first terminal device 520. If the service type associated with the first terminal device 520 is a predetermined service type, the network device 110 may determine the preconfigured switching condition is satisfied. If the preconfigured switching condition is determined to be satisfied, the network device 110 may transmit the second message to the first terminal device 520.

The second message may include at least one of a paging message, a short message and downlink control information (DCI), which will be discussed in details below. In a case where the first service providing mode is a multicast mode, and the second service providing mode is a unicast mode, the network device 110 may transmit the second message by transmitting, tothe first terminal device 520, the paging message indicating that the first terminal device 520 is to be served in the unicast mode. If the first terminal device 520 is in RRC_IDLE mode, after being paged, the terminal device 520 may convert to RRC_CONNECTED mode.

In some example embodiments, the paging message may include a temporary mobile group identity (TMGI) associated with the target service served in the multicast mode to the first terminal device 520.

In some other example embodiments, before transmitting the paging message, the network device 110 may scramble the paging message with a group radio network temporary identity (G-RNTI) associated with a group where the first terminal device 520 is grouped in. Only the terminal device 520 that is interested in the target service can descramble the paging message properly.

In some other example embodiments, before transmitting the paging message, the network device 110 may scramble the paging message with an I-RNTI associated with the first terminal device 520. A mapping of I-RNTI and the multicast services may be preconfigured at the first terminal device 520, for example, via a MCCH configuration message. In this case, the I-RNTI values may be reserved for respective temporary mobile group IDs (TMGI) associated with corresponding MBMS services. Table 1 shows an example of the mapping between I-RNGI and TMGI of MBMS services.

TABLE 1
The mapping between I-RNGI and TMGI

| ENTRY | I-RNTI | TMGI |
|---|---|---|
| 1 | 0x0001~0xFFF3 | ID1 |
| 2 | 0x0001~0xFFF3 | ID2 |

Conventionally, the network device 110 broadcasts the SIB periodically in the cell 104 for the purpose of saving signaling resources. Accordingly, the first terminal device 520 receives the SIB periodically, leading to a long period for updating the SIB. In a case where the first service providing mode is a multicast mode, and the second service providing mode is a unicast mode, the network device 110 may transmit the second message by transmitting a short message. In this case, the network device 110 may transmit, to the first terminal device 520, the short message for notifying the first terminal device 520 to receive the SIB. The network device 110 may then transmit, to the first terminal device 520, the SIB indicating that the first terminal device 520 is to be served in the unicast mode. As such, the network device 110 may update the SIB as needed, and the first terminal device 520 is capable of receiving additional SIBs in an aperiodic manner.

In some example embodiments, the network device 110 may add a list of services not to be served in the multicast mode in the SIB. For example, the network device 110 transmit the SIB indicating a list of TMGIs that has been stopped to be served. An example of the SIB that includes the list of services not to be served in the multicast mode according to some embodiments of the present disclosure is illustrated below.

```
MBSFN-AreaInfoList ::= SEQUENCE (SIZE(1..maxMBSFN-Area)) OF
MBSFN-AreaInfo
MBSFN-AreaInfo ::= SEQUENCE {
  mbsfn-AreaId MBSFN-AreaId,
  non-MBSFNregionLength ENUMERATED {s1, s2},
  notificationIndicator INTEGER (0..7),
  stoppedTMGIlist tmgi
  mcch-Config SEQUENCE {
}
```

In some other example embodiments, the network device 110 may remove scheduling information associated with services to be served in the multicast mode from the SIB. The scheduling information may be MCCH scheduling information for the MBSFN area 102. In this case, upon receipt the SIB, the terminal device 520 may find there is no MCCH scheduling information for the MBSFN area, which implicitly indicates that the network device 110 would no longer provide multicast services in this MBSFN area, guiding the terminal device 520 to enter RRC_CONNECTED mode for unicast communications. An example of the SIB that lacks scheduling information associated with service to be served in the multicast mode according to the present disclosure is illustrated below. As shown, the MBSFN area information is not included in the mbsfn-AreaInfoList.

### System Information Block

```
System InformationBlock Type X ::= SEQUENCE {
  mbsfn-AreaInfoList MBSFN-AreaInfoList,
  notificationConfi MBMS-NotificationConfig,
  ...,
  }
```

In a case where the first service providing mode is a multicast mode, and the second service providing mode is a unicast mode, the network device 110 may transmit the second message by transmitting the DCI, for example, the DCI format IC. In this case, the network device 110 may add TMGI associated with the target service served in the multicast mode to the first terminal device 520 in the DCI format IC.

Alternatively, in the above cases, the DCI is transmitted to notify the first terminal device 520 of monitoring a control channel, such as the MCCH. Conventionally, the network device 110 transmits configuration information on the MCCH periodically. In this embodiment, the network device 110 may transmit the DCI for conveying information for MCCH change notification. The information for MCCH change notification is an 8 bits bitmap for indicating which MBSFN area is updated. In this case, the network device 110 may then transmit, to the first terminal device 520, the switching information on the control channel. By means of the DCI, the network device 110 is capable of notifying the first terminal device 520 of change on MCCH, and thus the first terminal device 520 can receive information on the MCCH in the aperiodic and flexible manner.

In some example embodiments, the switching information transmitted in the control channel may indicate a Physical Multicast Channel (PMCH) list indicative of services to be served in the multicast mode, and the target service is excluded from the PMCH list. Upon receipt the DCI, the terminal device 520 may start to monitor the control channel, and determine the target service is no longer served in the multicast mode based on the switching information, for example, the Physical Multicast Channel (PMCH) list included in the MBSFNAreaConfiguration in MCCH. An example of the switching information indicative of a first list of services not to be served in the multicast mode according to the present disclosure is illustrated below. As shown, the PMCH information is not included in the switching information.

```
MBSFNAreaConfiguration-r9 ::= SEQUENCE {
    pmch-InfoList PMCH-InfoList,
    MBSFNAreaConfiguration OPTIONAL
}
PMCH-InfoList ::= SEQUENCE (SIZE (0..maxPMCH-PerMBSFN))
OF PMCH-Info
PMCH-Info ::= SEQUENCE {
    pmch-Config PMCH-Config,
    mbms-SessionInfoList MBMS-SessionInfoList,
  ...
}
```

In some other example embodiments, the switching information transmitted in the control channel may indicate a Multimedia Broadcast Multicast Service (MBMS) session list indicative of services to be served in the multicast mode, and the target service is excluded from the MBMS session list. Upon receipt the DCI, the terminal device 520 may start to monitor the control channel, and determine the target service is not included in the second list of services to be in the multicast mode based on the switching information, that is, the target service is no longer served in the multicast mode. An example of the switching information indicative of a second list of services to be served in the multicast mode according to the present disclosure is illustrated below. As shown, with the MBSM session information list, the network device 110 may ignore the MBMS session which stops the transmission.
MBMS-SessionInfoList::=SEQUENCE (SIZE (0..maxSessionPerPMCH)) OF MBMS-SessionInfo

In still other example embodiments, the switching information transmitted in the control channel may indicate that the target service is no longer served in the multicast mode, for example by including a list of services not to be provided in the multicast mode. An example of the switching information according to the present disclosure is illustrated below.

| | |
|---|---|
| MBMS-SessionInfo ::= | SEQUENCE { |
| tmgi | TMGI, |
| sessionId | OCTET STRING (SIZE (1)) |
| logicalChannelIdentity | INTEGER (0..maxSessionPerPMCH-1), |
| servicestopped | boolean, |
| ... | |
| } | |

In a case where more and more terminal devices are interested in MBMS services, the network device 110 may expect to switch the unicast mode to the multicast mode. In this case, the first service providing mode may be the unicast mode, and the second service providing mode may be the multicast mode. If the terminal device is camping in a cell and in RRC_IDLE mode, the terminal device can directly receive the SIB or the MCCH configurations to obtain the MBMS Point to Multipoint Radio Bearer (MRB) configurations for the MBMS service. However, if the terminal device is served by unicast mode and stays in RRC_CONNECTED mode, the terminal device 110 may need to command the terminal device to switch from the unicast mode to the multicast mode via RRC signaling.

In some example embodiments, the network device 110 transmits to the first terminal device 520, a RRC reconfiguration message which at least includes scheduling information about a list of services not to be served in the unicast mode. In this case, the network device 110 commands the terminal device 520 to switch to multicast mode via a RRC dedicated signalling. In this RRC dedicated signalling, the network device 110 may configure the MBSFN area information included in the SIB or MCCH in advance, so as to quickly enable the terminal device 520 to switch to multicast mode. A drb-ToReleaseList including the data resource bearer (DRB) for the unicast service and a TMGI-ToAddList configured for the new service to be served in the multicast mode may also be included in the RRC reconfiguration message. The terminal device 520 may not remove the context of the DRB for the unicast service until it successfully received the first packet from multicast. An example of the RRCReconfiguration message according to the present disclosure is illustrated below. As shown, the RRCReconfiguration message may include MBSFN area information including MCCH scheduling information, MCCH configurations that includes MTCH scheduling information.

### RRCReconfigurationComplete Message

| | |
|---|---|
| { | |
| mbsfn-AreaInfoList | MBSFN-AreaInfoList, |
| notificationConfig | MBMS-NotificationConfig, |
| commonSF-Alloc | CommonSF-AllocPatternList, |
| commonSF-AllocPeriod | ENUMERATED { |
| | rf4, rf8, rf16, rf32, rf64, rf128, rf256}, |
| pmch-InfoList- | PMCH-InfoList-r9, |
| drb-ToReleaseList | |
| TMGI-ToAddList | |
| } | |

Upon receipt of the RRC Reconfiguration message, the terminal device 120 is actually served in the multicast mode and unicast mode simultaneously. The terminal device 120 then transmits a third message, for example, an MBMS service indication or the like to the network device 110 to notify that the certain MBMS service has switched to multicast mode. An example of the third message according to the present disclosure is illustrated below.

```
MBMSInterestIndication ::= SEQUENCE {
  switchedmbms-ServiceList MBMS-ServiceList
  }
```

In the above example embodiments, the network device 110 may transmit, in response to the third message, a further RRC reconfiguration message to the at least one first terminal device 520 in the group for removing unicast configuration information about services served in the unicast mode.

Alternatively, in a case where the first service providing mode is a unicast mode, the second service providing mode is a multicast mode, and the first terminal device 520 operates in an RRC_IDLE mode, the network device 110 may transmit the second message by transmitting a RRCRelease message that at least includes multicast scheduling information about at least one service currently served in the unicast mode. An example of the RRC release message according to the present disclosure is illustrated below. As shown, the RRCRelease message may include MBSEN area information including MCCH scheduling information and MCCH configurations that includes MTCH scheduling information.

### RRCRelease Message

| | |
|---|---|
| RRCRelease ::= | SEQUENCE { |
| mbsfn-AreaInfoList | MBSFN-AreaInfoList, |
| notificationConfig | MBMS-NotificationConfig, |
| commonSF-Alloc | CommonSF-AllocPatternList, |
| commonSF-AllocPeriod-r1 | ENUMERATED { |
| | rf4, rf8, rf16, rf32, rf64, rf128, rf256}, |
| pmch-InfoList | PMCH-InfoList, |
| } | |

Upon receipt the second message, the terminal device 520 establishes 508, based on the switching information, a connection with the network device 110 to be served by the network device 110 in the second service providing mode. The network device 110 may then serve 510 the first terminal device 520 in the second service providing mode.

In a case where the multicast services (e.g., MBMS services) are changed or updated in one of the cells in the coverage of MBMS area 102, a corresponding network device managing the cell should share the information regarding the updated multicast services with its neighboring network devices via the X2 interface.

By way of example, the services served in the first service providing mode by the network device 110 are changed, and in this case, the network device 110 may transmit 512 a updating message indicating the updated services served in the first service providing mode to at least one neighboring network device of the network device 110, that is, the network device 130. In some example embodiments, the updating message transmitted in 512 may be a NG-RAN node Configuration Update message for updating the MBMS information of the network device 110. NG-RAN node Configuration Update message may include a MBSFN area id list, a TMGI list, a cell ID list, a frequency list and so on.

Additionally or alternatively, a further terminal device (not shown) served by the network device 130 may transmit multiple cell measurement results. In some cases, the network device 130 may determine that a handover for the further terminal device to the cell 104 of the network device 110 is required based on the cell measurement results. In such cases, the network device 130 is capable of performing smooth handover from the cell 106 of the network device 130 to the cell 104 of the network device 110 based on the TMGI list received from the network device 110.

By means of the updating message transmitted in 512, the source network device, namely, the network device 110 knows whether the target cell 106 of the target network device, namely, the network device 130 provides the same MBMS session with the source cell. Specifically, in a scenario of mobility of the terminal device 120, a possible handover may be performed from the cell 104 to the cell 106. The source network device, namely, the network device 110 may determine 514 the terminal device 520 is to be handed over from the source cell 104 to the target cell 106 of neighboring network device, namely, the network device 130. An example of the RRCReconfiguration message according to some embodiments of the present disclosure is illustrated below, which indicates the multicast service will not be supported by the target cell by including the TMGI list or the MRB list.

### RRCReconfijuration Message

| | |
|---|---|
| RRCReconfiguration ::= | SEQUENCE |
| TMGIlistHandoer | SEQUENCE (SIZE(1..maxMBMSsession)) OF TMGI |
| or | |
| MRBlistHandoer | SEQUENCE (SIZE(1..maxMRB)) OF MRB |
| } | |

The network device 110 determines 516 whether the first terminal device 520 is supported to be served in the first service providing mode in the target cell 106. For example, the source cell 104 may support the multicast services, while the target cell 106 may support the unicast service. In this case, the target cell 106 does not support the multicast service the terminal device 520 is interested in. If the source network device 110 determines that the first terminal device 520 is not supported to be served in the first service providing mode in the target cell, the source network device 110 transmits 518, to the terminal device 520, a request for reporting a serial number of the last packet associated with the multicast service received from the source cell 104. Upon receipt 522 a response indicative of the serial number of the last packet from the terminal device 520, the source network device 110 transmits 524, a fourth message indicating the serial number to the network device 130.

An example of the RRCReconfigurationComplete message according to some embodiments of the present disclosure is illustrated below, which indicates the PDCP SN that the target cell should transmit the packets from.

### RRCReconfigurationComplete Message

| | |
|---|---|
| RRCReconfigurationComplete ::= | SEQUENCE { |
| lastreceivedPDCPSNlist | SEQUENCE (SIZE(1..maxMBMSsession)) OF |
| PDCPSNofMBMSservice | |
| PDCPSNofMBMSservice | SEQUENCE ( |
| TMGI | |
| PDCPSN) | or |
| lastreceivedPDCPSNlist | SEQUENCE (SIZE(1..maxMRB)) OF |
| PDCPSNofMBMSservice | SEQUENCE ( |
| PDCPSNofMBMSservice | |
| MRB | |
| PDCPSN | |

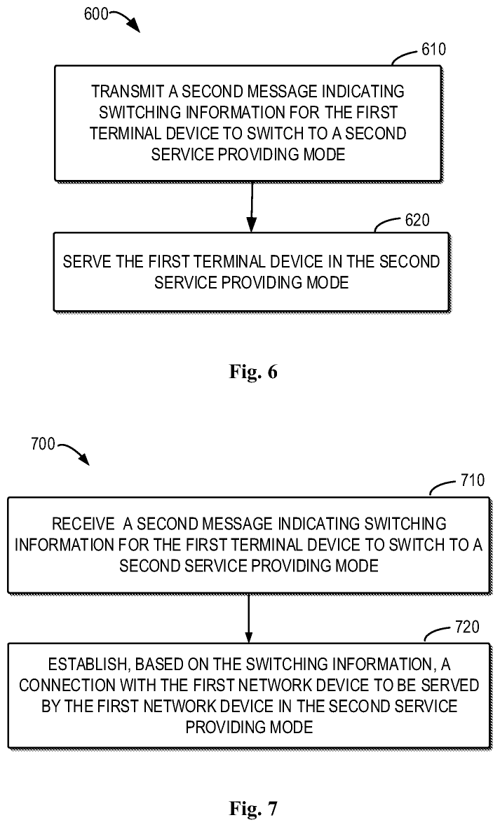

FIG. 6 illustrates a flowchart of an example method 600 in accordance with some embodiments of the present disclosure. For example, the method 600 can be performed at the network device 110 as shown in FIGS. 1-2. It is to be understood that the method 600 may include additional blocks not shown and/or may omit some blocks as shown, and the scope of the present disclosure is not limited in this regard.

At 610, the network device 110 transmits, to the first terminal device520, a second message indicating switching information for the first terminal device 520 to switch to a second service providing mode. The first terminal device 520 is served by the network device 110 in a first service providing mode. By way of example, the first terminal device 520 is currently served with a target service in the first providing mode.

In some example embodiments, the network device 110 may determine a first service metric associated with a first terminal device 520 for triggering the switching of the service providing mode. The network device 110 may determine whether a preconfigured switching condition is satisfied based on the first service metric. In some example embodiments, the first service metric may include a number of terminal devices in a group where the first terminal device 520 is grouped in. In such embodiments, the network device 110 determines the number of the terminal devices in the group. If the number of the terminal devices in the group is below a predetermined number threshold, the network device 110 may determine that the preconfigured switching condition is satisfied.

In some other example embodiments, the first service metric may include a service type associated with a multicast service served to the first terminal device 520. In such embodiments, the network device 110 determines the service type associated with the first terminal device 520. If the service type is a predetermined service type, the network device 110 may determine that the preconfigured switching condition is satisfied.

If the preconfigured switching condition is satisfied, the network device 110 may transmit, to the first terminal device 520, the second message indicating switching information for the terminal device 520 to switch to a second service providing mode.

In some example embodiments, the first service providing mode is the multicast mode, and the second service providing mode is the unicast mode, and the second message transmitted in 610 may include a paging message. In such embodiments, the network device 110 transmits, to the first terminal device 520, the paging message indicating that the first terminal device 520 is to be served in the unicast mode.

In some example embodiments, the network device 110 may transmit the paging message including a temporary mobile group identity (TMGI) associated with the target service served in the multicast mode to the first terminal device 520.

In some example embodiments, the network device 110 may transmit the paging message scramble with one of a G-RNTI associated with a group where the first terminal device 520 is grouped in and an I-RNTI associated with the first terminal device 520. In such cases, a mapping of the I-RNTI to the service is preconfigured at the group of first terminal device 520.

In some example embodiments, the first service providing mode is the multicast mode, and the second service providing mode is the unicast mode, and the second message transmitted in 610 may include a short message. In such embodiments, the network device 110 may transmit, to the first terminal device 520, the short message for notifying the first terminal device 520 to receive system information block. The network device 110 may then transmit, to the first terminal device 520, the SIB indicating that the first terminal device 520 is to be served in the unicast mode.

To indicate the switching information, in some example embodiments, the network device 110 may add a list of services not to be served in the multicast mode in the SIB. In some other example embodiments, the network device 110 may remove scheduling information associated with at least one service to be served in the multicast mode from the SIB.

In some example embodiments, the first service providing mode is the multicast mode, and the second service providing mode is the unicast mode, and the second message transmitted in 610 may include DCI. In such embodiments, the network device 110 may transmit the DCI including a temporary mobile group identity (TMGI) associated with the target service served in the multicast mode to the first terminal device 520.

Alternatively, in the above cases, the network device 110 may transmit the DCI for notifying the first terminal device 520 of monitoring a control channel. The network device 110 may then transmit the switching information on the control channel. In some example embodiments, the switching information may include a Physical Multicast Channel (PMCH) list indicative of services to be served in the multicast mode, and the target service is excluded from the PMCH list. In some other example embodiments, the switching information may indicate may include a Multimedia Broadcast Multicast Service (MBMS) session list indicative of services to be served in the multicast mode, and the target service is excluded from the MBMS session list. In still other example embodiments, the switching information may include a list of services not to be provided in the multicast mode, and the target service is included in the list.

In some example embodiments, the first service providing mode is the multicast mode, and the second service providing mode is the unicast mode, and the second message transmitted in 610 may include a RRC reconfiguration message. In such embodiments, the network device 110 may transmit the RRC reconfiguration message at least including scheduling information about a list of services not to be served in the unicast mode to the first terminal device 520. In addition, after a multicast connection is established between the network device 110 and the first terminal device 520, the network device 110 may receive, from the first terminal device 520, a third message indicating that the switching to the multicast mode has been completed. The network device 110 may transmit, in response to the third message, a further RRC reconfiguration message to the first terminal device 520 for removing unicast configuration information about at least one service served in the unicast mode.

In a case where the first terminal device operates in an RRC_IDLE mode, the first service providing mode is the multicast mode, and the second service providing mode is the unicast mode, the second message transmitted in 610 may include a RRC release message. In such embodiments, the network device 110 may transmit the RRC release message which at least includes multicast scheduling information about at least one service currently served in the unicast mode.

At 620, the network device 110 serves the first terminal device 520 in the second service providing mode. In the above example, upon switching, the network device may serve the target service in the second service providing mode.

FIG. 7 illustrates a flowchart of an example method 700 in accordance with some embodiments of the present disclosure. For example, the method 700 can be performed at the terminal device 120 or 520 as shown in FIG. 1 or 5, respectively. It is to be understood that the method 700 may include additional blocks not shown and/or may omit some blocks as shown, and the scope of the present disclosure is not limited in this regard.

At 710, the first terminal device 520 receives a second message indicating switching information for the terminal device 110 to switch to a second service providing mode. In some example embodiments, the first service providing mode may be the multicast mode, the second service providing mode may be the unicast mode, and the second message received in 710 may include a paging message. In such embodiments, the first terminal device 520 may receive, from the network device 110, the paging message indicating that the first terminal device 520 is to be served in the unicast mode.

In some example embodiments, the paging message may include the TMGI associated with the target service served in the multicast mode to the first terminal device 520. In some other example embodiments, the paging message may be scrambled with a predetermined RNTI associated with the first terminal device 520. In such embodiments, upon receipt the scrambled paging message, the first terminal device 520 may descramble the paging message with the predetermined RNTI, such as the G-RNTI associated with a group where the first terminal device 520 is grouped in, I-RNTI and so on. The mapping of the RNTI with the at least one service may be preconfigured at the group of the first terminal device 520.

In some example embodiments, the first service providing mode may be the multicast mode, the second service providing mode may be the unicast mode, and the second message received in 710 may include a short message. In such embodiments, the first terminal device 520 may receive, from the network device 110, the short message for notifying the first terminal device 520 to receive the SIB. The first terminal device 520 may then receive from the network device 110, the SIB indicating that the first terminal device 520 is to be serviced in the unicast mode.

In the above embodiments, the SIB may include a list of services not to be served in the multicast mode to the first terminal device 520. Based on the list of services, the first terminal device 520 may determine that the target service is no longer served in the multicast mode.

Alternatively, in the above embodiments, scheduling information associated with services to be served in the multicast mode to the first terminal device 520 may be removed from the SIB. That is, the SIB may lack scheduling information associated with services to be served in the multicast mode. Upon receipt the SIB, the first terminal device 520 obtains no scheduling information associated with services to be served in the multicast mode from the SIB. In such cases, the first terminal device 520 may determine that the target service is no longer served in the multicast mode.

In some example embodiments, the first service providing mode may be the multicast mode, the second service providing mode may be the unicast mode, and the second message received in 710 may include DCI. In such embodiments, The DCI may include the TMGI associated with the target service served in the multicast mode to the first terminal device 520. Alternatively, the first terminal device 520 may receive, from the network device 110, the DCI for notifying of monitoring a control channel. The first terminal device 520 may then receive the switching information on the control channel. In such cases, the switching information may indicates at least one of the PMCH list indicative of services to be served in the multicast mode, the target service being excluded from the PMCH list; the MBMS session list indicative of services to be served in the multicast mode, the target service being excluded from the MBMS session list; and a list of services not to be provided in the multicast mode, the target service being included in the list.

In some example embodiments, the first service providing mode may be the unicast mode, the second service providing mode may be the multicast mode, and the second message received in 710 may include a RRC reconfiguration message. In such embodiments, the first terminal device 520 may receive, from the network device 110, the RRC reconfiguration message that at least includes scheduling information about a list of services not to be served in the unicast mode to the first terminal device 520.

In some example embodiments, the first service providing mode may be the unicast mode, the second service providing mode may be the multicast mode, and the first terminal device 520 operates in the RRC_IDLE/INACTIVE mode, the second message received in 710 may be a RRC release message. In such embodiments, the first terminal device 520 may receive the RRC release message that at least includes multicast scheduling information about at least one service currently served in the unicast mode.

At 720, the first terminal device 520 establishes, based on the switching information, a connection with the network device 110 to be served by the network device 110 in the second service providing mode.

In some example embodiments, after the establishment of the unicast connection, the first terminal device 520 may determine whether the connection with the network device 110 is established successfully. At this point, the first terminal device 520 may receive services in both the multicast mode and the unicast mode simultaneously. If the connection is determined to be established successfully, the first terminal device 520 may transmit, to the network device 110, a third message indicating that the switching to the second service providing mode has been completed. The first terminal device 520 may then receive, from the network device 110, a further radio resource control reconfiguration message to remove unicast configuration information about services served in the unicast mode.

In order to ensure a smooth handover from the source cell 104 to the target cell 106 in a mobility scenario, the first terminal device 520 may be requested to report the serial number of the last packet received from the network device 110, for example, PDCP SN for each MRB/TMGI. In this case, the first terminal device 520 may receive from the network device 110, a request for reporting a serial number of a last packet associated with the multicast service received from the source cell 104. In response to the request, the first terminal device 520 may transmit, to the network device 110, a response indicative of the serial number of the last packet.

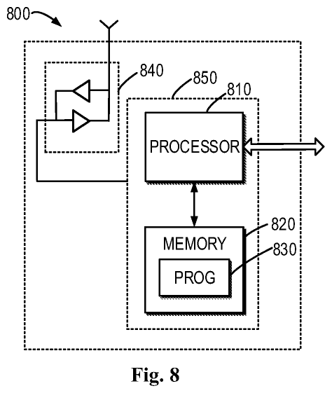

FIG. 8 illustrates an example signaling chart showing an example process 800 for updating the supporting multicast services within the MBMS area in accordance with some embodiments of the present disclosure. As shown in FIG. 8, the process 800 may involve the network devices 110 and 130 as shown in FIG. 1. It is to be understood that the process 800 may include additional acts not shown and/or may omit some acts as shown, and the scope of the present disclosure is not limited in this regard. In addition, it will be appreciated that, although primarily presented herein as being performed serially, at least a portion of the acts of the process 800 may be performed contemporaneously or in a different order than as presented in FIG. 8.

FIG. 8 is a simplified block diagram of a device 800 that is suitable for implementing embodiments of the present disclosure. The device 800 can be considered as a further example implementation of the network devices 110 and 130 and the terminal device 120 as shown in FIG. 1, and the terminal device 520 as shown in FIG. 5. Accordingly, the device 800 can be implemented at or as at least a part of the network devices 110 and 130, or the terminal devices 120 and 520.

As shown, the device 800 includes a processor 810, a memory 820 coupled to the processor 810, a suitable transmitter (TX) and receiver (RX) 840 coupled to the processor 810, and a communication interface coupled to the TX/RX 840. The memory 810 stores at least a part of a program 830. The TX/RX 840 is for bidirectional communications. The TX/RX 840 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 830 is assumed to include program instructions that, when executed by the associated processor 810, enable the device 800 to operate in accordance with the embodiments of the present disclosure, as discussed herein with reference to FIGS. 1 to 7. The embodiments herein may be implemented by computer software executable by the processor 810 of the device 800, or by hardware, or by a combination of software and hardware. The processor 810 may be configured to implement various embodiments of the present disclosure. Furthermore, a combination of the processor 810 and memory 820 may form processing means 850 adapted to implement various embodiments of the present disclosure.

The memory 820 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 3-4 and 6-7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote readable media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method for communications, comprising:
receiving, at a terminal device and from a network device, a first message indicative of a switching condition for the terminal device to switch to a second service providing mode, the terminal device being served by the network device in a first service providing mode; and
in accordance with a determination that the switching condition is satisfied, establishing a connection with the network device to be served by the network device in the second service providing mode.

2. The method of claim 1, wherein receiving the first message comprises:
receiving a system information block comprising information indicative of the switching condition.

3. The method of claim 1, wherein receiving the first message comprises:
receiving a system information block indicating a set of configurations to be transmitted on a control channel, the set of configurations at least comprising the switching condition; and
obtaining the switching condition from the set of configurations based on the system information block.

4. The method of claim 1, wherein the terminal device is served, by the network device, with a target service in the first service providing mode, the switching condition indicates that a signal strength value of a first signal received from the network device does not exceed a predetermined signal strength threshold associated with the target service, and wherein the method further comprises:
measuring the signal strength value of the first signal; and
in accordance with a determination that the signal strength value of the first signal does not exceed the predetermined signal strength threshold, determining that the switching condition is satisfied.

5. The method of claim 1, wherein the switching condition indicates that a first ratio of packets successfully received at the terminal device in the first service providing mode to a total packets transmitted from the network device in the first service providing mode does not exceed a predetermined ratio, and wherein the method further comprises:
receiving the packets in the first service providing mode from the network device;
determining the first ratio of packets being successfully received in the first service providing mode to the total packets being transmitted in the first service providing mode; and
in accordance with a determination that the first ratio does not exceed the predetermined ratio, determining that the switching condition is satisfied.

6. The method of claim 1, wherein the first service providing mode comprises a multicast mode, and the second service providing mode comprises a unicast mode.

7. A method for communications, comprising:
transmitting, to a terminal device, a first message indicative of a switching condition for serving the terminal device in a second service providing mode, the terminal device being served by the network device in a first service providing mode; and
performing an establishment of a connection with the terminal device for serving the terminal device in the second service providing mode.

8. The method of claim 7, wherein the terminal device is served, by the network device, with a target service in the first service providing mode and the switching condition indicates at least one of the following:
a signal strength value of a first signal transmitted by the network device being not exceeding a predetermined signal strength threshold associated with the target service; and
a first ratio of packets successfully received at the terminal device in the first service providing mode to total packets transmitted from the network device in the first service providing mode being not exceeding a predetermined ratio.

9. The method of claim 7, wherein transmitting the first message comprises:
transmitting a system information block comprising the switching condition.

7. The method of claim 7, wherein transmitting the first message comprises:
transmitting, to the terminal device, a system information block indicating a set of configurations to be transmitted on a control channel, the set of configurations at least comprising the switching condition; and
transmitting, to the terminal device, the set of configurations on the control channel.

11. The method of claim 7, wherein the first service providing mode comprises a multicast mode, and the second service providing mode comprises a unicast mode.

12. A method for communications, comprising:
transmitting, at a first network device and to a first terminal device, a second message indicating switching information for the first terminal device to switch to a second service providing mode, the first terminal device being served by the first network device in a first service providing mode; and
serving the first terminal device in the second service providing mode.

13. The method of claim 12, wherein the first service providing mode is a multicast mode, and the second service providing mode is a unicast mode, and wherein transmitting the second message indicating the switching information comprises:
transmitting, to the first terminal device, a paging message indicating that the first terminal device is to be served in the unicast mode.

14. The method of claim 13, wherein transmitting the paging message comprises one of the following:
transmitting the paging message comprising a temporary mobile group identity (TMGI) associated with a target service served in the multicast mode to the first terminal device;
transmitting the paging message scrambled with a group radio network temporary identity (G-RNTI) associated with a group where the first terminal device is grouped in; and
transmitting the paging message scrambled with an I-RNTI associated with the first terminal device.

15. The method of claim 12, wherein the first service providing mode is a multicast mode, and the second service providing mode is a unicast mode, and wherein transmitting the second message indicating the switching information comprises:
transmitting, to the first terminal device, a short message for notifying the first terminal device to receive a system information block; and
transmitting, to the first terminal device, the system information block indicating that the first terminal device is to be served in the unicast mode.

16. The method of claim 15, further comprising:
adding, in the system information block, a list of services not to be served, in the multicast mode, to first terminal device; and
removing, from the system information block, scheduling information associated with at least one service to be served, in the multicast mode, to the first terminal device.

17. The method of claim 12, wherein the first service providing mode is a multicast mode, and the second service providing mode is a unicast mode, and wherein transmitting the second message indicating the switching information comprises:
transmitting, to the first terminal device, downlink control information comprising a temporary mobile group identity (TMGI) associated with a target service served in the multicast mode to the first terminal device.

18. The method of claim 12, wherein the first service providing mode is a multicast mode, the second service providing mode is a unicast mode, the first terminal device being served with a target service in the multicast mode, and wherein transmitting the second message indicating the switching information comprises:
transmitting, to the first terminal device, downlink control information (DCI) for notifying the first terminal device of monitoring a control channel; and
transmitting, to the first terminal device, the switching information on the control channel, the switching information comprising at least one of the following:
a Physical Multicast Channel (PMCH) list indicative of services to be served in the multicast mode, the target service being excluded from the PMCH list;
a Multimedia Broadcast Multicast Service (MBMS) session list indicative of services to be served in the multicast mode, the target service being excluded from the MBMS session list; and
a list of services not to be provided in the multicast mode, the target service being included in the list.

19. The method of claim 12, wherein the first service providing mode is a unicast mode, and the second service providing mode is a multicast mode, and wherein transmitting the second message indicating the switching information comprises:
transmitting, to the first terminal device, a radio resource control reconfiguration message at least including scheduling information about a list of services not to be served in the unicast mode.

20. The method of claim 19, further comprising:
receiving, from the first terminal device, a third message indicating that the switching to the multicast mode has been completed; and
transmitting, to the first terminal device, a further radio resource control reconfiguration message to remove unicast configuration information about at least one service served in the unicast mode.

21. The method of claim 12, wherein the first service providing mode is a unicast mode, and the second service providing mode is a multicast mode, and wherein transmitting the second message indicating the switching information comprises:
in accordance with a determination that the first terminal device operates in an RRC_IDLE mode, transmitting, to the first terminal device, a radio resource control release message at least including multicast scheduling information about at least one service currently served in the unicast mode.

22. The method of any of claims 12 to 21, further comprising:
transmitting, to at least one neighboring network device of the first network device, a updating message indicating updated services served, by the first network device, in a multicast mode.

23. The method of any of claims 12 to 21, wherein the first terminal device is served, by the first network device, with a multicast service, and the method further comprises:
in accordance with a determination that the first terminal device is to be handed over from a source cell of the first terminal device to a target cell of the first network device, determining whether the multicast service is supported to be served in the multicast mode in the target cell; and
in accordance with a determination that the multicast service is not supported to be served in the multicast mode:
transmitting, to the first terminal device, a request for reporting a serial number of a last packet associated with the multicast service received from the source cell;
receiving, from the first terminal device, a response indicative of the serial number of the last packet; and
transmitting, to a second network device managing the target cell, a fourth message indicating the serial number.

24. A method for communications, comprising:
receiving, at a first terminal device and from a first network device, a second message indicating switching information for the first terminal device to switch to a second service providing mode, the first terminal device being served by the first network device in a first service providing mode; and
establishing, based on the switching information, a connection with the first network device to be served by the first network device in the second service providing mode.

25. The method of claim 24, wherein the first service providing mode is a multicast mode, and the second service providing mode is a unicast mode, and wherein receiving the second message indicating the switching information comprises:
receiving, from the first network device, a paging message indicating that the first terminal device is to be served in the unicast mode.

26. The method of claim 25, wherein receiving the paging message comprises:
receiving the paging message comprising a temporary mobile group identity (TMGI) associated with a target service served in the multicast mode to the first terminal device.

27. The method of claim 25, wherein the paging message is scrambled with a predetermined radio network temporary identity (RNTI) associated with the first terminal device, and wherein the method further comprises:
descrambling the paging message with the predetermined RNTI, wherein the predetermined RNTI comprises at least one of the following:
a group radio network temporary identity (G-RNTI) associated with a group where the first terminal device is grouped in; and
an I-RNTI associated with the first terminal device.

28. The method of claim 24, wherein the first service providing mode is a multicast mode, and the second service providing mode is a unicast mode, and wherein receiving the second message indicating the switching information comprises:
receiving, from the first network device, a short message for notifying the first terminal device to receive a system information block; and
receiving, from the first network device, the system information block indicating that the first terminal device is to be serviced in the unicast mode.

29. The method of claim 28, wherein receiving the system information block comprises at least one of the following:
receiving the system information block including a list of services not to be served, in the multicast mode, to the first terminal device; and
receiving the system information block without scheduling information associated with at least one service to be served, in the multicast mode, to the first terminal device.

30. The method of claim 24, wherein the first service providing mode is a multicast mode, and the second service providing mode is a unicast mode, and wherein receiving the second message indicating the switching information comprises:
receiving downlink control information comprising a temporary mobile group identity (TMGI) associated with a target service served in the multicast mode to the first terminal device.

31. The method of claim 24, wherein the first service providing mode is a multicast mode, and the second service providing mode is a unicast mode, and wherein receiving the second message indicating the switching information comprises:
receiving, from the first network device, downlink control information for notifying the first terminal device of monitoring a control channel; and
receiving the switching information on the control channel, the switching information indicating at least one of the following:
a Physical Multicast Channel (PMCH) list indicative of services to be served in the multicast mode, the target service being excluded from the PMCH list;
a Multimedia Broadcast Multicast Service (MBMS) session list indicative of services to be served in the multicast mode, the target service being excluded from the MBMS session list; and
a list of services not to be provided in the multicast mode, the target service being included in the list.

32. The method of claim 24, wherein the first service providing mode is a unicast mode, and the second service providing mode is a multicast mode, and wherein receiving the second message indicating the switching information comprises:
receiving, from the first network device, a radio resource control reconfiguration message at least including scheduling information about a list of services not to be served in the unicast mode.

33. The method of claim 32, further comprising:
in accordance with a determination that the connection with the first network device is established successfully, transmitting, to the first network device, a third message indicating that the switching to the second service providing mode has been completed; and
receiving, from the first network device, a further radio resource control reconfiguration message to remove unicast configuration information about at least one service served in the unicast mode.

34. The method of any of claims 24-33, wherein the first terminal device is served, by the first network device, with a multicast service, and the method further comprises:
during handover from a source cell of the first network device to a target cell of a second network device, receiving, from the first network device, a request for reporting a serial number of a last packet associated with the multicast service received from the source cell; and
transmitting, to the first network device, a response indicative of the serial number of the last packet.

35. A terminal device, comprising:
a processor; and
a memory coupled to the processor and storing instructions thereon, the instructions, when executed by the processor, causing the terminal device to perform the method according to any of claims 1-6.

36. A terminal device, comprising:
a processor; and
a memory coupled to the processor and storing instructions thereon, the instructions, when executed by the processor, causing the terminal device to perform the method according to any of claims 24-34.

37. A network device, comprising:
a processor; and
a memory coupled to the processor and storing instructions thereon, the instructions, when executed by the processor, causing the network device to perform the method according to any of claims 7-11.

38. A network device, comprising:
a processor; and
a memory coupled to the processor and storing instructions thereon, the instructions, when executed by the processor, causing the network device to perform the method according to any of claims 12-23.
